(19) United States
(12) Patent Application Publication
(10) Pub. No.: US 2007/0194248 A1
(43) Pub. Date: Aug. 23, 2007

(54) Methods of using rare-earth oxide compositions and related systems

(75) Inventors: Valery Victor Belov, Allentown, NJ (US); Howard Y. Bell, Princeton, NJ (US); Victoria Ann Bell, Princeton, NJ (US); Tatyana Belov, Allentown, NJ (US)

Correspondence Address: SYNNESTVEDT LECHNER & WOODBRIDGE LLP, P O BOX 592, 112 NASSAU STREET, PRINCETON, NJ, 08542-0592, US

(73) Assignee: Sunstone Technology, Inc., Allentown, NJ (US)

(21) Appl. No.: 11/549,056

(22) Filed: Oct. 12, 2006

Related U.S. Application Data
(60) Provisional application No. 60/725,796, filed on Oct. 12, 2005.
(60) Provisional application No. 60/742,009, filed on Dec. 2, 2005.

(51) Int. Cl. G01J 1/58; C09K 11/02

(52) U.S. Cl. 250/458.1

(57) ABSTRACT

A method for communicating between a surface containing a rare-earth oxide phosphor, which emits a second wavelength photon when excited by a first wavelength photon, and an article mounted on a device, wherein the method includes exciting the phosphor with a source that emits a first wavelength photon to produce a second wavelength photon response in the surface; and detecting the second wavelength photon with a means in communication with the article, wherein the article is capable of emitting a signal based upon receipt of the second wavelength photon.

### CROSS-REFERENCE TO RELATED APPLICATIONS

This application claims priority under 35 U.S.C. § 119(e) to U.S. Provisional Application Ser. No. 60/725,796, which was filed on Oct. 12, 2005. The disclosure of this application is incorporated herein by reference.

### BACKGROUND OF THE INVENTION

Phosphors are materials which absorb energy and release the absorbed energy in the form of electromagnetic radiation, most typically as visible light. Where the phosphor absorbs energy from electromagnetic radiation impinging on the phosphor this radiation may be referred to as “exciting” radiation. Where the absorbed energy is released immediately, the phenomenon is known as “fluorescence.” For example, a material which exhibits fluorescence may emit visible light while excited by ultraviolet light impinging upon the material.

Where the energy of the exciting electromagnetic radiation is stored within the phosphor and released in response to additional electromagnetic radiation, referred to as “stimulating” radiation, the phenomenon is referred to as “stimulated emission.” For example, a phosphor exhibiting the behavior referred to as stimulated emission may be exposed to ultraviolet radiation, and exhibit no appreciable glow after the ultraviolet exposure. However, when this phosphor is treated with infrared stimulating radiation, it may emit substantial quantities of visible light. The term “luminescence” includes all of these phenomena, as well as other phenomena involving absorption of energy within a material and release of that energy as electromagnetic radiation, most typically, but not necessarily, as visible light. The term “phosphor” thus includes all luminescent materials.

Phosphors can be categorized in accordance with their behavior as fluorescent, phosphorescent, or stimulable. A “stimulable” phosphor is one which, at room temperature, stores energy absorbed upon exposure to exciting electromagnetic radiation and releases the predominant portion of the stored energy upon exposure to stimulating electromagnetic radiation. A phosphorescent phosphor at room temperature will store absorbed energy for an appreciable time but will release the predominant portion of the stored energy spontaneously. A fluorescent phosphor will release the predominant portion of the absorbed energy as emission radiant energy substantially simultaneously with exposure to the exciting radiant energy.

### SUMMARY OF THE INVENTION

The present invention utilizes rare-earth oxide phosphors for communicating between a surface and an article. A method is presented for communicating between a surface containing a rare-earth oxide phosphor, which emits a second wavelength photon when excited by a first wavelength photon, and an article, wherein the method includes exciting the phosphor with a photon source that emits a first wavelength photon to emit a second wavelength photon from the surface; and detecting the second wavelength photon with a means mounted to the article, wherein the article provides a signal upon receipt of the second wavelength photon. The signal can be an electromagnetic, audio, or visual signal. The signal can be in either an analog or digital form.

One embodiment includes a system for communicating between a surface containing a rare-earth oxide phosphor, which emits a second wavelength photon when excited by a first wavelength photon, and an article, wherein the system includes a source that emits a first wavelength photon to produce a second wavelength photon emission from the surface; and a detector means for receiving the second wavelength photon mounted to the article, wherein the article produces a signal upon receipt of the second wavelength photon.

Another embodiment includes a composition for marking a surface, which includes a rare-earth oxide phosphor, which emits a second wavelength photon when stimulated by a first wavelength photon, dispersed or suspended in a material comprising the surface, a carrier, or a combination thereof.

### BRIEF DESCRIPTION OF THE DRAWINGS

FIG. 1 is an absorption curve and an emission curve for Aluminum/Galium/Gadolinium;

FIG. 2a is an absorption curve for Thulium oxysulfide;

FIG. 2b is am emission curve for Thulium oxysulfide;

FIG. 3a is an absorption curve for Thulium oxysulfide with impurities in the crystal structure;

FIG. 3b is am emission curve for Thulium oxysulfide with impurities in the crystal structure;

FIG. 4a is an absorption curve for Gadolinium/Ytterbium/Erbium oxysulfide;

FIG. 4b is am emission curve for Gadolinium/Ytterbium/Erbium oxysulfide;

FIG. 5a is an absorption curve for Gadolinium oxysulfide activated with Erbium and Ytterbium;

FIG. 5b is am emission curve for Gadolinium oxysulfide activated with Erbium and Ytterbium;

FIG. 6 depicts one embodiment wherein the source and detector are mounted to a bus for guidance at a railroad crossing;

FIG. 7 depicts one embodiment wherein the source and detector are mounted to a bus for guidance on a bridge; and

FIG. 8 is a picture of and block diagrams for a source/detector means for use in the present invention.

### DETAILED DESCRIPTION OF THE INVENTION

The present invention relates to methods and systems for communicating between a surface, which includes a rare-earth oxide phosphor, and an article. The rare-earth oxide phosphor crystals have unique optical properties. Specifically, the phosphors are able to convert energy in the electromagnetic spectrum. Rare-earth oxide phosphors used in the present invention are invisible to the eye and the photons emitted therefrom are machine readable.

Therefore, a method according to the present invention includes exciting the surface phosphor with a source that emits photons of a first wavelength to emit photons of a second wavelength from the surface; and detecting the second wavelength photons with a means mounted on an article, wherein the article provides a signal upon detection of the second wavelength photons.

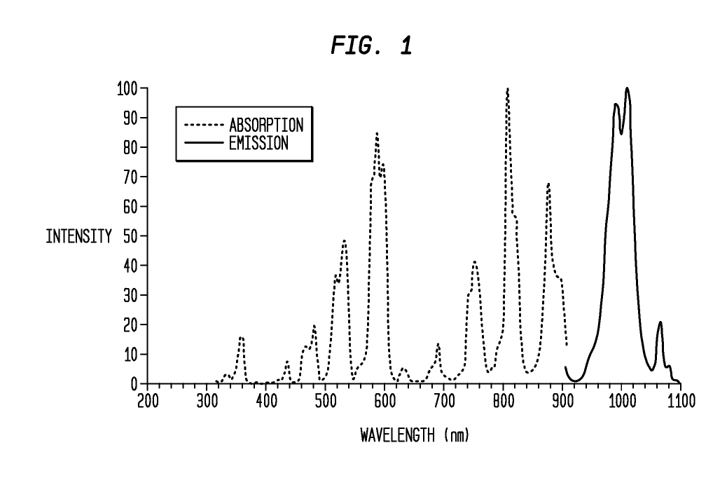

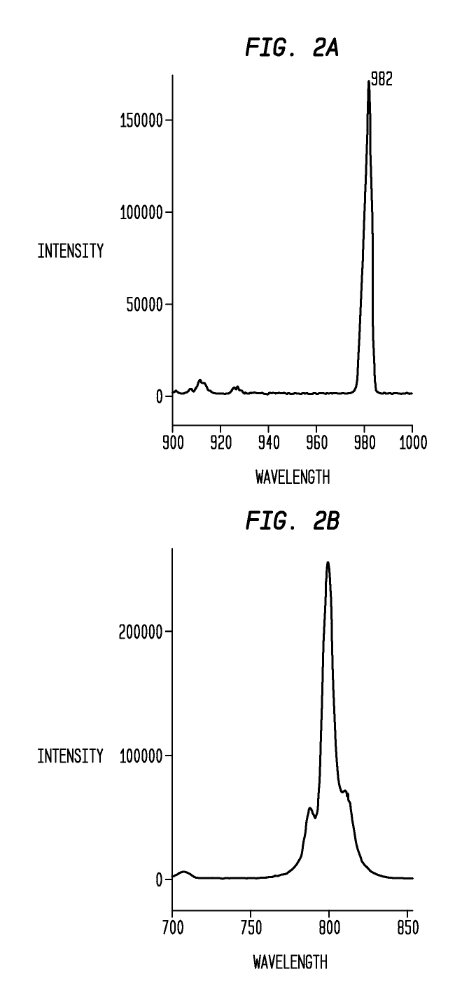

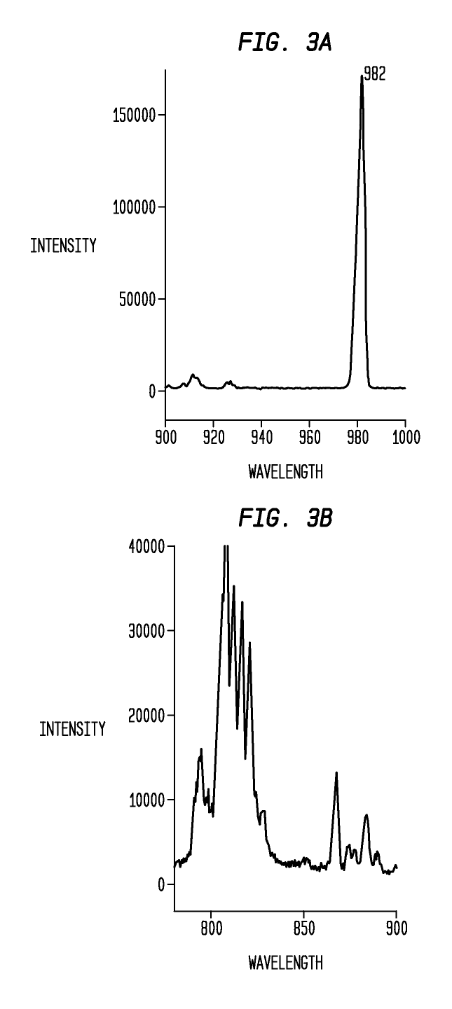

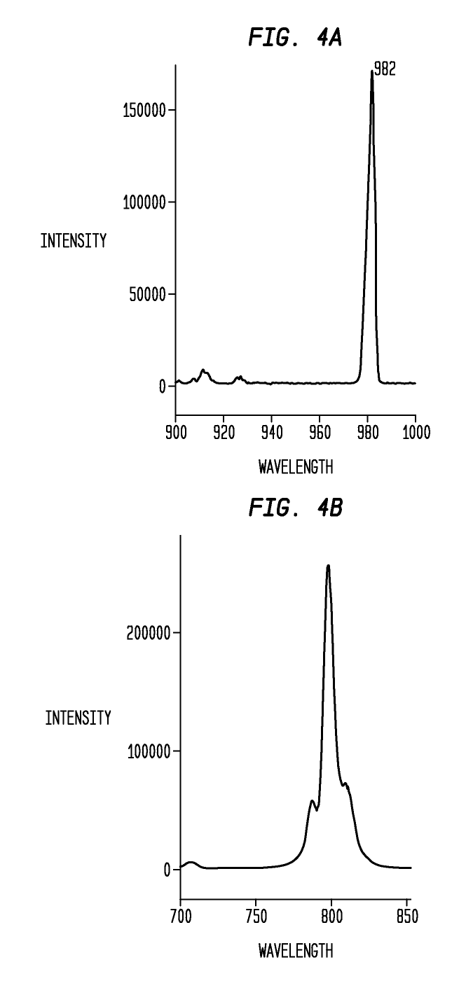

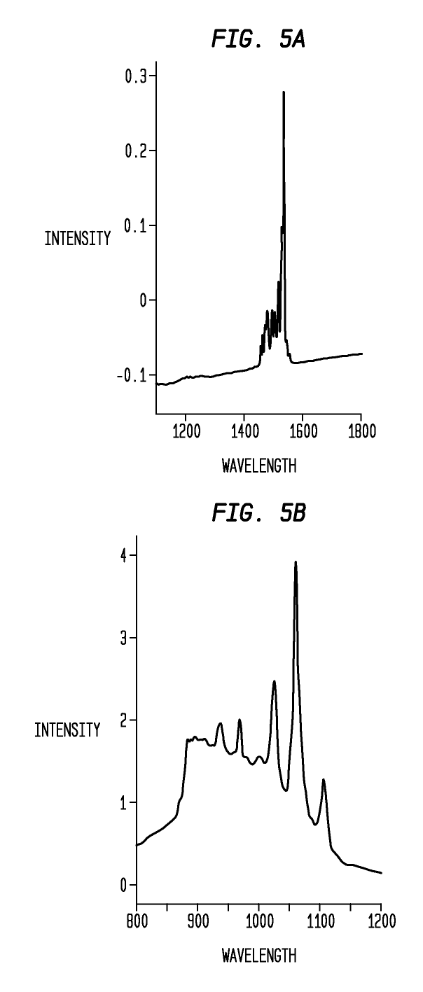

Rare-earth oxide phosphors suitable for use in the present invention are capable of being excited to a higher energy state upon exposure to a first wavelength. The excited phosphors then emit photons of a second wavelength as the phosphor relaxes to its lower energy ground state. For example, when exposed to infrared radiation of 950 nm, Yttrium/Thulium/Ytterbium Oxide (Y₂Tm₂Yb₂O₃) crystals (Sunstones, Sunstones, Inc., Allentown, N.J.), emit photons with a wavelength of 800 nm. Preferred phosphors include, but are not limited to, Yttrium/Thulium/Ytterbium Oxide (Y₂Tm₂Yb₂O₃), Aluminum/Galium/Gadolinium (FIG. 1), Thulium oxysulfide (FIGS. 2a and b), Thulium oxysulfide with impurities in the crystal structure (FIGS. 3a and b), Yttrium/Erbium/Ytterbium oxysulfide, Gadolinium/Ytterbium/Erbium oxysulfide (FIGS. 4a and b), and Gadolinium oxysulfide activated with Erbium and Ytterbium (FIGS. 5a and b). Additional suitable rare-earth oxide phosphors are readily determinable by those skilled in the art.

Exemplary methods for preparing rare-earth oxide phosphors are disclosed below in the Examples. Preferred methods for preparing rare-earth oxide phosphors are disclosed in U.S. application Ser. Nos. 11/537,035 and 11/537,159, filed on Sep. 29, 2006, the disclosures of both of which are incorporated herein by reference.

The rare-earth oxide phosphors used in the present invention are excited to a higher energy state with photons of a suitable first wavelength. Preferred first photons have wavelengths in the ultraviolet, visible, and infrared regions. Infrared wavelength photons are the most preferred first excitation photons because of their ability to penetrate snow, ice, or mud covering a portion of a surface, such as a road or sidewalk, and excite the phosphor. A source, which emits a suitable first wavelength photon, is used for exciting the phosphor. Preferred sources include, but are not limited to, light-emitting diodes (LEDs), lasers, flashlights, headlights, and sunlight.

The excited phosphors produce second photons with wavelengths ranging from 200 nm to 25,000 nm. The second wavelength photons include photons with wavelengths different from the first excitation wavelength photons to avoid interference of the first wavelength photons with the detector means. Preferred detector means include, but are not limited to, silicon detectors, charge-coupled device (CCD) cameras, photomultiplier tubes, and two-dimensional InSb or HgCdTe infrared detector arrays.

Additionally, the frequencies and the decay times of these rare-earth oxide phosphors can be controlled. The decay time relates to the length of time the phosphor will emit photons, or, ‘glow,’ after the excitation source is discontinued. The decay time can range from about a femtosecond to about 6 hours. The decay time can be measured, for example, by synchronizing a pulsing source and a detector means to the appropriate decay time of the phosphor. If the phosphor has a decay time of 1 millisecond the detector and source would be set to 1 KHz frequency. For example, Yttrium/Thulium/Ytterbium Oxide crystals, when excited by a 1 KHz, pulsed 950 nm LED, will produce a 800 nm (+/−3 nm) wavelength photons with a 1 KHz frequency.

The rare-earth oxide is combined with a surface for providing information to an article. Suitable surfaces include, but are not limited to, a second article surface, a road, a bridge, a sign, a roadside object, a sidewalk curb, a train platform, a floor, wood, or a combination thereof. The rare-earth oxide phosphor can be combined with the surface material alone (e.g. dispersed in the material) or while incorporated into a carrier (e.g. coated on the surface in a carrier). For example, the phosphors are robust enough to be combined with asphalt or concrete prior to the formation of a roadway or sidewalk surface. The phosphor can also be suspended in an oil-based or latex paint or urethane coating for application to a surface. Whatever medium into which the phosphor is dispersed must be sufficiently optically transparent to the first and second photon wavelengths. Sufficient transparency can be readily determined by one of ordinary skill in the art.

Suitable articles for use in the present invention include any article that can provide an electromagnetic, audio, or visual signal after receiving photons that essentially convey information about a surface. For example, the phosphors can be incorporated in a driving environment (e.g. surfaces of signs and roads) to alert a driver of a vehicle about an upcoming necessary action, such as stopping the vehicle at a stop sign. Exemplary devices include, but are not limited to, vehicles, robots, saws, and canes for visually impaired users. Suitable vehicles include, but are not limited to, automobiles, automatic guided vehicles, wheelchairs, toy vehicles, buses, ambulances, and snowplows.

The articles emit an electromagnetic, audio, or visual signal to initiate or request an action upon receipt of the second wavelength photon, which provides information about a surface, for example, the presence of a surface or a quality of the surface. The action can be initiated by a user of the device upon receipt of an audio or visual signal or initiated automatically by the device itself upon receipt of an electromagnetic, audio, or visual signal by, for example, a microprocessor controller. Exemplary actions of the article include, but are not limited to, steering a device to follow a path that includes the phosphor, stopping a device after detecting the phosphor, and avoiding a second device after detecting a phosphor on the second device.

Another aspect of the present invention includes a method for providing a means for communication between a surface and an article by applying a composition, which includes a rare-earth oxide phosphor, which emits a second wavelength photon when stimulated by a first wavelength photon, to the surface. Yet another aspect of the present invention includes a composition for marking a surface, which includes a rare-earth oxide phosphor, which emits a second wavelength photon when stimulated by a first wavelength photon, dispersed or suspended in a material comprising the surface, a carrier, or a combination thereof.

The method of the present invention can be used whenever it is necessary for a surface to communicate with an article.

For example, one specific use includes incorporating the phosphor into a road, road paint, signs and other areas of the driving environment. The first wavelength photon could come from, for example, an LED located under the vehicle. A detector means would be focused on the portion of the surface contacted by the first wavelength photon. When detected, emission of the second wavelength photon will provide information to the operator of the vehicle by triggering an audio alarm or activating a visible light on the vehicle dashboard to alert the operator to take a necessary action such as slowing the vehicle, stopping the vehicle, or steering the vehicle.

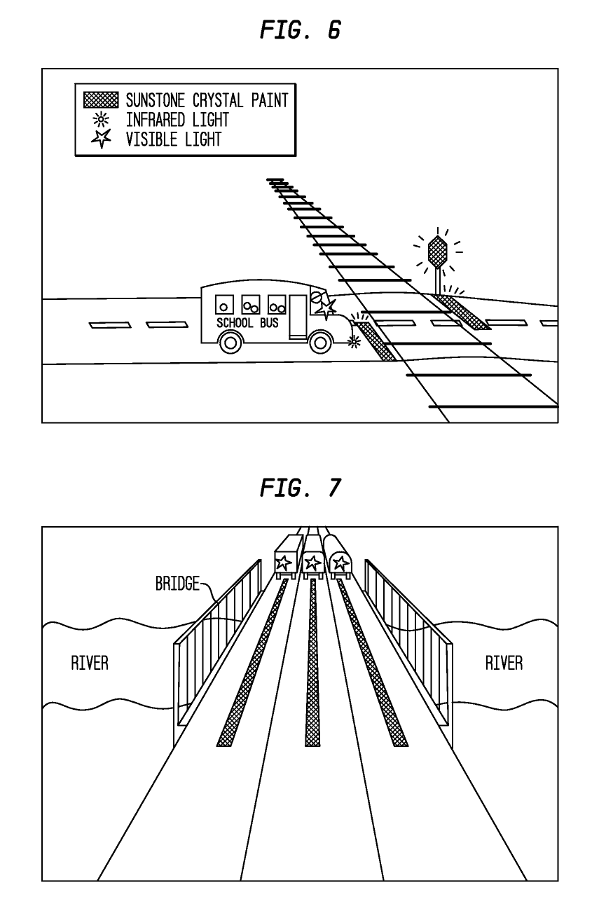

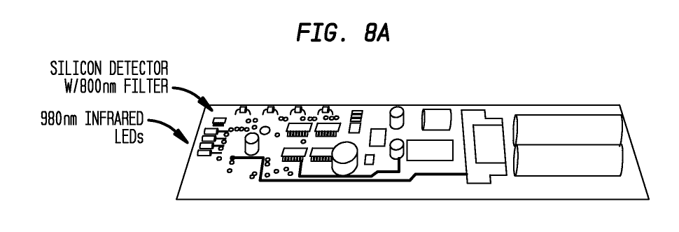

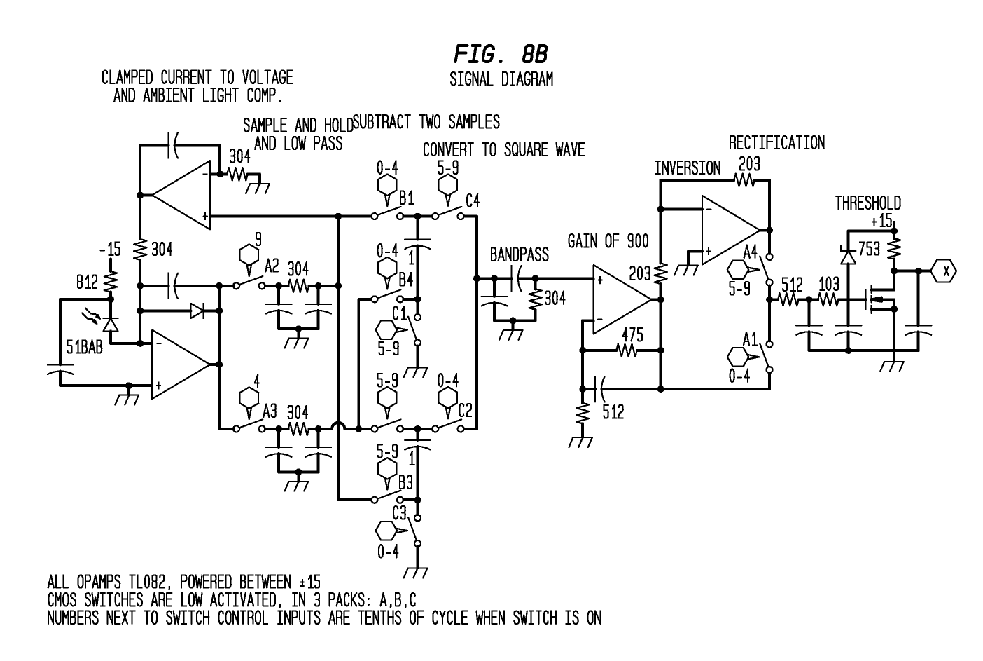

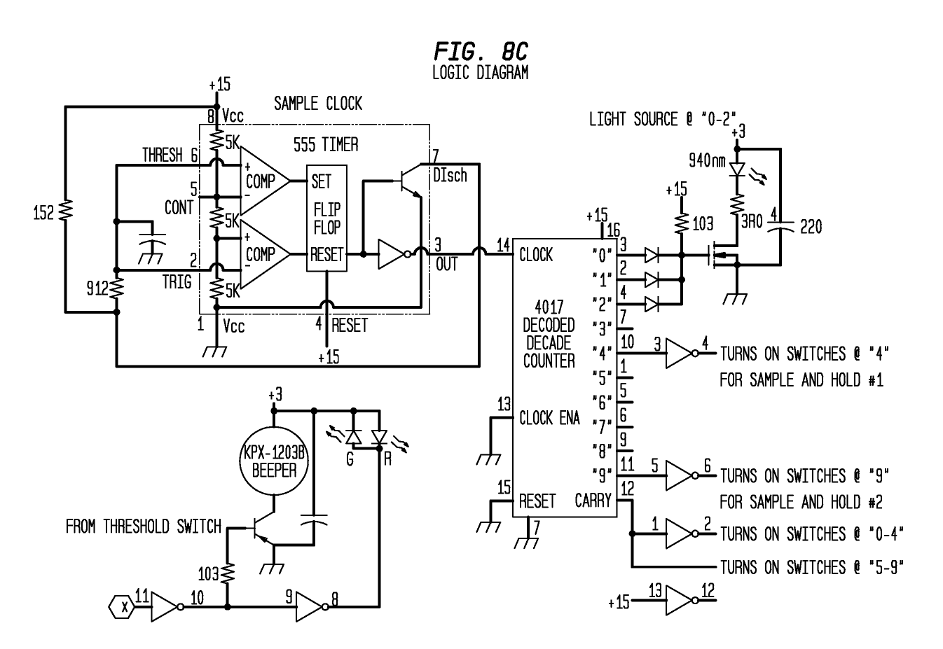

Another use, depicted in FIG. 6, includes incorporating the phosphor into a road or road paint at a railroad crossing. The first wavelength photon comes from a source mounted to a school bus. A detector means mounted to the school bus is focused on the portion of the surface contacted by the first wavelength photon. When detected, emission of the second wavelength photon will provide information to the operator of the bus by activating a light on the dashboard or sounding an alarm to alert the operator to stop the bus at the railroad crossing.

Another use, depicted in FIG. 7, includes incorporating the phosphor into the lanes of a bridge that are narrower than the lanes of the road leading to the bridge. The first wavelength photon comes from a source mounted to a vehicle, for example, a bus. A detector means mounted to the vehicle is focused on the portion of the surface contacted by the first wavelength photon. When detected, emission of the second wavelength photon will provide information to the operator of the vehicle by activating a light on the dashboard or sounding an alarm to alert the operator to stay on course, or the vehicle can automatically follow the phosphor to successfully navigate the bridge.

Another use includes incorporating the phosphor into a road or road paint. The first wavelength phosphor comes from an infrared source mounted to a snowplow. The infrared wavelength photons would penetrate the substance covering the road, such as snow, ice, or mud to excite the rare-earth oxide phosphor. A detector means mounted to the snowplow is focused on the portion of the surface contacted by the first wavelength photon. When detected, emission of the second wavelength photon will provide information to the operator of the snowplow by activating a system in the snowplow by means of an electromagnetic signal, to provide the operator the navigational information he or she needs.

Another use includes incorporating the phosphor into a road or road paint. The first wavelength photon comes from a source mounted to an ambulance. A detector mounted to the ambulance is focused on the portion of the surface contacted by the first wavelength photon. When detected, emission of the second wavelength photon will provide information to the operator of the ambulance by means of an electromagnetic signal to a system in the ambulance to provide the operator with navigational information, for example, information for finding a designated address.

Another use includes incorporating the phosphor into a road or road paint in a series of two or more lines to monitor the speed of a vehicle. The first wavelength photon comes from a source mounted to the vehicle. A detector mounted to the vehicle is focused on the portion of the surface contacted by the first wavelength photon. When the vehicle passes a first line containing the phosphor, a detector on the vehicle recognizes the second wavelength photon from the phosphor, which starts a microprocessor clock. A second line in a 25 mile per hour zone, for example, would be painted 110 feet from the first line. When the vehicle passes the second line and detects the second wavelength photon from the phosphor in the second line, the clock stops. A car traveling 25 miles per hour will travel 110 feet in 3 seconds. If the time period between the two strips is faster than 3 seconds, the vehicle is traveling faster than 25 miles per hour. The clock may activate an audio or visual warning signal or engage a speed governor or braking system to slow the vehicle.

Another use includes incorporating the phosphor into a web for a printing process. A detector mounted to a printer is focused on the portion of the surface of the web contacted by the first wavelength photon. When detected, the second wavelength photon will provide information to the operator of the printer by activating a system in the printer to alert the operator that the web is off or that the end of the print run is approaching.

The following non-limiting example set forth herein below illustrates certain aspects of the invention.

### EXAMPLES

### Example 1

Preparation of Thulium Oxysulfide

The following were combined: 22 g Yttrium Oxide (Y₂O₃) (MV Labs w588a); 3.59 g Ytterbium Oxide (Yb₂O₃) (Aesar R32284); 0.2 g Thulium Oxide (Tm₂O₃) (MV Labs R588a); 12 g sulfur (Spectrum Chemical 08841R); and 12 g sodium carbonate (Malinkrodt 7527KBNC) and mixed for 30 minutes. The mixture was then placed in a 50 cc crucible, covered with lid, and put into a box furnace at set point of 1100° C. for 1 hour. The composition was then removed from the furnace and washed in 5 gallons of water to produce a wet material cake. The cake was placed in an aluminum pan in a box oven at 105° C. for 3 hours. The thulium oxysulfide is then suspended in an oil-based paint for application to surfaces.

### Example 2

Preparation of Gadolinium/Ytterbium/Erbium oxysulfide

The following were combined: 16 g Gadolinium Oxide; 3 g Ytterbium Oxide (Yb₂O₃) (Aesar R32284); 6 g Yttrium Oxide (Y₂O₃) (MV Labs w588a); 2 g Erbium Oxide; 12 g sulfur (Spectrum Chemical 08841R); and 12 g sodium carbonate (Malinkrodt 7527KBNC) and mixed for 30 minutes. The mixture was then placed in a 50 cc crucible, covered with lid, and put into a box furnace at set point of 1100° C. for 1 hour. The composition was then removed from the furnace and washed in 5 gallons of water to produce a wet material cake. The cake was placed in a aluminum pan in a box oven at 105° C. for 3 hours. The Gadolinium/Ytterbium/Erbium oxysulfide is then suspended in an oil-based paint for application to surfaces.

### Example 3

Preparation of Aluminum/Galium/Gadolinium

The following were combined: 2 g Aluminum Oxide; 9 g Galium Oxide; and 11 g Gadolinium Oxide and mixed for 30 minutes. The mixture was then placed in a 50 cc crucible, covered with lid, and put into a box furnace at set point of 1600° C. for 1 hour. The composition was then removed from the furnace and washed in 5 gallons of water to produce a wet material cake. The cake was placed in an aluminum pan in a box oven at 105° C. for 3 hours. The Aluminum/Galium/Gadolinium is then suspended in an oil-based paint for application to surfaces.

### Example 4

Preparation of Yttrium/Erbium/Ytterbium oxysulfide

The following were combined: 22 g Yttrium Oxide (Y₂O₃) (MV Labs w588a); 3 g Ytterbium Oxide (Yb₂O₃) (Aesar R32284); 2 g Erbium Oxide; 12 g sulfur (Spectrum Chemical 08841R); and 12 g sodium carbonate (Malinkrodt 7527KBNC) and mixed for 30 minutes. The mixture was then placed in a 50 cc crucible, covered with lid, and put into a box furnace at set point of 1100° C. for 1 hour. The composition was then removed from the furnace and washed in 5 gallons of water to produce a wet material cake. The cake was placed in an aluminum pan in a box oven at 105° C. for 3 hours. The Yttrium/Erbium/Ytterbium oxysulfide is then suspended in an oil-based paint for application to surfaces.

The foregoing examples and description of the preferred embodiments should be taken as illustrating, rather than as limiting the present invention as defined by the claims. As will be readily appreciated, numerous variations and combinations of the features set forth above can be utilized without departing from the present invention as set forth in the claims. Such variations are not regarded as a departure from the spirit and script of the invention, and all such variations are intended to be included within the scope of the following claims.

What is claimed is:

1. A method for communicating between a surface comprising a rare-earth oxide phosphor, which emits a second wavelength photon when excited by a first wavelength photon, and an article mounted on a device, wherein the method comprises:
(a) exciting said phosphor with a source that emits a first wavelength photon to produce a second wavelength photon response in the surface; and
(b) detecting said second wavelength photon with a detector in communication with said article, wherein said article is adapted to emit a signal upon detection of said second wavelength photon.

2. The method of claim 1, wherein said surface comprises a second device surface, a road, a bridge, a sign, a roadside object, a sidewalk curb, a train platform, a floor, wood, or a combination thereof.

3. The method of claim 1, wherein said device comprises a vehicle, a robot, a saw, or a cane for a visually impaired user.

4. The method of claim 3, wherein said vehicle comprises an automobile, an automatic guided vehicle, a wheelchair, a toy vehicle, a bus, an ambulance, or a snowplow.

5. The method of claim 1, wherein said phosphor comprises Yttrium/Thulium/Ytterbium Oxide (Y₂Tm₂Yb₂O₃); Aluminum/Galium/Gadolinium; Thulium oxysulfide; Thulium oxysulfide with impurities in the crystal structure; Yttrium/Erbium/Ytterbium oxysulfide; Gadolinium/Ytterbium/Erbium oxysulfide; Gadolinium oxysulfide activated with Erbium and Ytterbium; or a combination thereof.

6. The method of claim 1, wherein said source comprises an LED, a laser, a flashlight, a headlight, sunlight, or a combination thereof.

7. The method of claim 1, wherein said detector means comprises a silicon detector, a CCD camera, a photomultiplier tube, or a two-dimensional InSb or HgCdTe infrared detector array.

8. The method of claim 1, wherein said signal initiates or requests an action by a user of said device.

9. The method of claim 1, wherein said signal is an electromagnetic, audio, or visual signal.

10. The method of claim 1, wherein said signal is an analog signal.

11. The method of claim 1, wherein said signal is a digital signal.

12. The method of claim 8, wherein said action is automatically initiated by said device in response to an electromagnetic, audio, or visual signal.

13. The method of claim 12, wherein said action comprises following a path comprising said phosphor, stopping a movement, avoiding a second article comprising said phosphor, or a combination thereof.

14. A method for providing a means for communication between a surface and an article comprising applying a composition comprising a rare-earth oxide phosphor, which emits a second wavelength photon when stimulated by a first wavelength photon, to said surface.

15. A composition for marking a surface comprising a rare-earth oxide phosphor, which emits a second wavelength photon when stimulated by a first wavelength photon, dispersed in a material comprising said surface, a carrier, or a combination thereof, wherein said surface and carrier are optically transparent to said first and second photon wavelengths.

16. A system for communicating between a surface comprising a rare-earth oxide phosphor, which emits a second wavelength photon when excited by a first wavelength photon, and an article mounted on a device, wherein the system comprises:
(a) a source that emits a first wavelength photon to produce a second wavelength photon response in the surface; and
(b) a means for detecting said second wavelength photon in communication with said article, wherein said article is capable of emitting a signal upon receipt of said second wavelength photon.

17. The system of claim 16, wherein said surface comprises a second device surface, a road, a bridge, a sign, a roadside object, a sidewalk curb, a train platform, a floor, wood, or a combination thereof.

18. The system of claim 16, wherein said device comprises a vehicle, a robot, a saw, or a cane for a visually impaired user.

19. The system of claim 18, wherein said vehicle comprises an automobile, an automatic guided vehicle, a wheelchair, a toy vehicle, a bus, an ambulance, or a snowplow.

20. The system of claim 16, wherein said phosphor comprises Yttrium/Thulium/Ytterbium Oxide (Y₂Tm₂Yb₂O₃); Aluminum/Galium/Gadolinium; Thulium oxysulfide; Thulium oxysulfide with impurities in the crystal structure; Yttrium/Erbium/Ytterbium oxysulfide; Gadolinium/Ytterbium/Erbium oxysulfide; Gadolinium oxysulfide activated with Erbium and Ytterbium; or a combination thereof.

21. The system of claim 16, wherein said source comprises an LED, a laser, a flashlight, a headlight, sunlight, or a combination thereof.

22. The system of claim 16, wherein said detector means comprises a silicon detector, a CCD camera, or a two-dimensional InSb or HgCdTe infrared detector array.

23. The system of claim 16, wherein said signal is an electromagnetic, audio, or visual signal.

24. The system of claim 16, wherein said signal is an analog signal.

25. The system of claim 16, wherein said signal is a digital signal.
